(19) United States
(12) Patent Application Publication
(10) Pub. No.: US 2017/0336631 A1
(43) Pub. Date: Nov. 23, 2017

(54) Dynamic Vergence for Binocular Display Device

(71) Applicant: Rockwell Collins, Inc., Cedar Rapids, IA (US)

(72) Inventor: Michael J. Armstrong, Central City, IA (US)

(21) Appl. No.: 15/157,739

(22) Filed: May 18, 2016

(51) Int. Cl. G02B 27/01; G02B 27/00; H04N 5/225; H04N 13/02

(52) U.S. Cl. CPC G02B 27/017; H04N 13/0282; G02B 27/0093; H04N 5/225

(57) ABSTRACT

A device, system, and method. The device includes a memory and a processor communicatively coupled to the memory. The processor may be configured to receive synthetic image data corresponding to a determined current location and orientation of a user's eye and a determined current location of a vergence point corresponding to the user's gaze. The processor may be configured to generate a left stream of left synthetic images based on the synthetic image data, the determined current location and orientation of the user's left eye, and the determined current location of the vergence point. The processor may be configured to generate a right stream of right synthetic images based on the synthetic image data, the determined current location and orientation of the user's right eye, and the determined current location of the vergence point. The processor may be configured to output the left and right streams.

### BACKGROUND

Binocular helmet-mounted displays (HMDs) are typically designed with a single, fixed vergence distance. This results in imagery appearing to come from a particular distance, unlike natural human vision. Natural human vision relies on changing focus and vergence to maintain single vision perception of objects of interest. Single, fixed vergence distance may be suitable when graphical data being displayed is symbol-based and all objects displayed are relatively far from an aircraft. However, with respect to more fully immersive scenes, such as when displaying synthetic vision and when the aircraft is low to the ground, the binocular HMD displays objects in both a near field and a far field simultaneously. For a binocular HMD with a single, fixed vergence distance, the pilot can only easily focus on objects at a distance similar to the single, fixed vergence distance but cannot easily “look around” in the scene. Attempting to focus on parts of the scene other than at the fixed vergence point can cause excessive eye fatigue and double vision.

### SUMMARY

In one aspect, embodiments of the inventive concepts disclosed herein are directed to a device. The device includes a memory and a processor communicatively coupled to the memory. The processor may be configured to receive synthetic image data corresponding to a determined current location and orientation of a user's eye and a determined current location of a vergence point corresponding to the user's gaze. The processor may be configured to generate a left stream of left synthetic images based on the synthetic image data, the determined current location and orientation of the user's left eye, and the determined current location of the vergence point. The processor may be configured to generate a right stream of right synthetic images based on the synthetic image data, the determined current location and orientation of the user's right eye, and the determined current location of the vergence point. The processor may be configured to output the left and right streams.

In a further aspect, embodiments of the inventive concepts disclosed herein are directed to a method. The method may include receiving, by a processor, synthetic image data corresponding to a determined current location and orientation of an eye of a user and a determined current location of a vergence point corresponding to a gaze of the user. The method may also include generating, by the processor, a left stream of left synthetic images based on the synthetic image data, a determined current location and orientation of the left eye of the user, and the determined current location of the vergence point. The method may additionally include generating, by the processor, a right stream of right synthetic images based on the synthetic image data, a determined current location and orientation of the right eye of the user, and the determined current location of the vergence point. The method may further include outputting, by the processor, the left stream of the left synthetic images. The method may also include outputting, by the processor, the right stream of the right synthetic images.

In a further aspect, embodiments of the inventive concepts disclosed herein are directed to system for a vehicle. The system may include a left display unit, a right display unit, and a processor communicatively coupled with the left display unit and the right display unit. The left display unit may be configured to present left images as video to a left eye of a user. The right display unit may be configured to present right images as video to a right eye of the user. The processor may be configured to receive synthetic image data corresponding to a determined current location and orientation of the user's eye and a determined current location of a vergence point corresponding to the user's gaze. The processor may be configured to generate a left stream of left synthetic images based on the synthetic image data, the determined current location and orientation of the user's left eye, and the determined current location of the vergence point. The processor may be configured to generate a right stream of right synthetic images based on the synthetic image data, the determined current location and orientation of the user's right eye, and the determined current location of the vergence point. The processor may further be configured to output the left stream of the left synthetic images to the left display unit configured to present the left stream as video to the left eye of the user. The processor may also be configured to output the right stream of the right synthetic images to a right display unit configured to present the right stream as video to the right eye of the user.

### BRIEF DESCRIPTION OF THE DRAWINGS

Implementations of the inventive concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 is a view of an exemplary embodiment of a system including an aircraft, a control station, satellites, and global positioning system (GPS) satellites according to the inventive concepts disclosed herein.

FIG. 2 is a view of the eye tracking system of FIG. 1 of an exemplary embodiment according to the inventive concepts disclosed herein.

FIG. 3 is a view of the aircraft sensors of FIG. 1 of an exemplary embodiment according to the inventive concepts disclosed herein.

FIG. 4 is a view of the helmet tracking system of FIG. 1 of an exemplary embodiment according to the inventive concepts disclosed herein.

FIG. 5 is a view of a portion of the aircraft of FIG. 1 of an exemplary embodiment according to the inventive concepts disclosed herein.

FIG. 6 is a view of a portion of the aircraft of FIG. 1 of an exemplary embodiment according to the inventive concepts disclosed herein.

FIG. 7A is a diagram of a pilot's eyes gazing on a physical object according to an exemplary embodiment according to the inventive concepts disclosed herein.

FIG. 7B is a diagram of a left virtual camera, a right virtual camera, and a rendered object corresponding to the left eye and right eye gazing on the physical object of FIG. 7A according to an exemplary embodiment according to the inventive concepts disclosed herein.

FIG. 8A is view of a left synthetic image of a synthetic vision scene according to an exemplary embodiment according to the inventive concepts disclosed herein.

FIG. 8B is view of a right synthetic image of the synthetic vision scene depicted in FIG. 8A according to the inventive concepts disclosed herein.

FIG. 8C is a view of vergence lines from virtual camera locations associated with the left and right synthetic images of FIGS. 8A-B according to an exemplary embodiment according to the inventive concepts disclosed herein.

FIG. 9A is view of a left synthetic image of a synthetic vision scene according to an exemplary embodiment according to the inventive concepts disclosed herein.

FIG. 9B is view of a right synthetic image of the synthetic vision scene depicted in FIG. 9A according to the inventive concepts disclosed herein.

FIG. 9C is a view of vergence lines from virtual camera locations associated with the left and right synthetic images of FIGS. 9A-B according to an exemplary embodiment according to the inventive concepts disclosed herein.

FIG. 10 is a diagram of an exemplary embodiment of a method according to the inventive concepts disclosed herein.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to a method, system, and a device. A display device (e.g., a binocular display device, such as a helmet-mounted display) may be configured to present a synthetic stereoscopic video stream to a user (e.g., a pilot), whereby the stereoscopic video stream may be adjusted in substantially real time to match the user's gaze. For example, an eye tracking system may detect and provide a direction in which each eye of the user is looking at any given time and track the direction in which each eye of the user is looking in substantially real time. The eye tracking system may generate and output updated (e.g., constantly updated, iteratively updated, or intermittently updated) eye location and orientation data to any device of the system. For example, as most recent eye location and orientation data is received, a processor of the system may determine a most recent vergence point of a user's gaze based on the direction in which each eye is looking and angles between the two directions. Based on the determined vergence point and imagery data for a particular environment, a processor of the system may generate and output left synthetic images and right synthetic images to be presented by a left display unit and a right display unit, respectively, of the binocular display device. Each of the left synthetic images synthetic images may be generated (e.g., iteratively generated) in substantially real time such that each of the left synthetic images is generated as if viewed from a location of the left eye in a direction toward a most recently determined vergence point, which corresponds to a direction of the user's gaze. Each of the right synthetic images may be generated (e.g., iteratively generated) in substantially real time such that each of the right synthetic images is generated as if viewed from a location of the right eye in a direction toward a most recently determined vergence point, which corresponds to a direction of the user's gaze. The processor may generate (e.g., render) each of the synthetic images (e.g., left synthetic images and right synthetic images) from a particular virtual camera location (which may also be referred to as viewpoint or “eye point”). For each scene, the scene may be generated twice, once from a left eye viewpoint and once from a right eye viewpoint, so that left synthetic images and right synthetic images may be presented on a left display unit and a right display unit, respectively, to the user. The processor may adjust the virtual camera locations to correspond to the locations and orientations of the user's eyes so that the user's viewing experience conforms to what the user would see if viewing a non-virtual environment.

When the user changes the direction of the user's gaze or a location of the user's eyes change, the processor generates left and right synthetic images as if viewed from current locations of the left eye and right eye, respectively, in a direction toward a currently determined vergence point which corresponds to (e.g., matches) the user's current gaze. The left display unit and the right display unit of the binocular display device display the left synthetic images and right synthetic images to the left and right eyes, respectively, of the user as stereoscopic video. By generating and displaying stereoscopic video as if viewed from the location of each eye of the user toward a current vergence point, the pilot can focus on all objects in the scene regardless of a distance from the user.

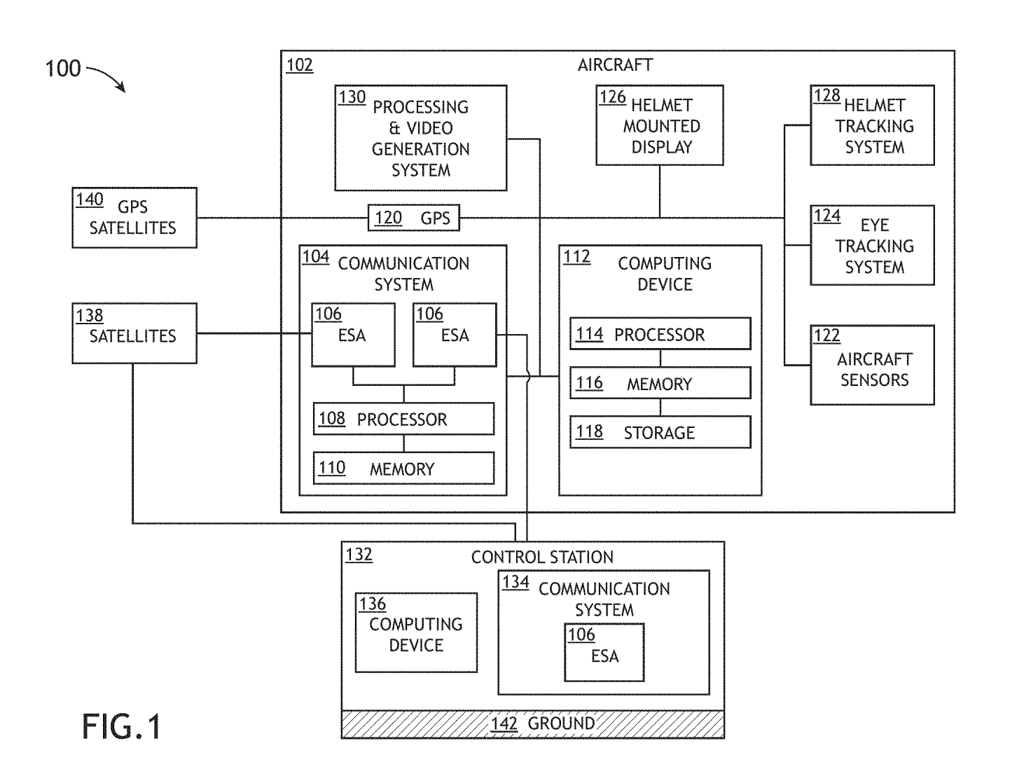

Referring now to FIG. 1, an exemplary embodiment of a system 100 according to the inventive concepts disclosed herein includes at least one aircraft 102, a control station 132, satellites 138, and global positioning system (GPS) satellites 140. Some or all of the aircraft 102, the control station 132, the satellites 138, and the global positioning system (GPS) satellites 140 may be communicatively coupled at any given time.

The aircraft 102 includes at least one communication system 104, at least one computing device 112 (which may also be referred to as at least one aircraft computing device or at least one helicopter computing device), a GPS device 120, aircraft sensors 122, at least one eye tracking system 124, at least one binocular display device (e.g., a helmet-mounted display 126 or a head-mounted display), at least one helmet tracking system 128, and at least one processing and video generation system 130, as well as other systems, equipment, and devices commonly included in aircraft. The binocular display device is exemplarily shown as the helmet-mounted display 126; however, in some embodiments, the binocular display device may be implemented as any suitable binocular display device. Some or all of the communication system 104, the computing device 112, the GPS device 120, the aircraft sensors 122, the eye tracking system 124, the helmet-mounted display 126, the helmet tracking system 128, the processing and video generation system 130, and any other systems, equipment, and devices commonly included in the aircraft 102 may be communicatively coupled. The aircraft 102 may be implemented as any suitable aircraft, such as a helicopter or airplane. While the system 100 is exemplarily shown as including the aircraft 102, in some embodiments the inventive concepts disclosed herein may be implemented in or on any suitable vehicle (e.g., an automobile, train, submersible craft, watercraft, or spacecraft) or any suitable environment.

The communication system 104 includes one or more antennas (e.g., two electronically scanned arrays (ESAs) 106, as shown), a processor 108, and memory 110, which are communicatively coupled. The communication system 104 (such as via one or more of the ESAs 106) is configured to send and/or receive signals, data, messages, and/or voice transmissions to and/or from the control station 134, other vehicles, the satellites 138, and combinations thereof, as well as any other suitable devices, equipment, or systems. That is, the communication system 104 is configured to exchange (e.g., bi-directionally exchange) signals, data, messages, and/or voice communications with any other suitable communication system (e.g., which may be implemented similarly and function similarly to the communication system 104).

The communication system 104 may include at least one processor 108 configured to run various software applications or computer code stored in a non-transitory computer-readable medium (e.g., memory 110) and configured to execute various instructions or operations. For example, the processor 108 may be configured to receive data from the computing device 112 and execute instructions configured to cause a particular ESA of the ESAs 106 to transmit the data as a signal(s) to another communication system (e.g., 134) of the system 100. Likewise, for example, the processor 108 may be configured to route data received as a signal(s) by a particular ESA of the ESAs 106 to the computing device 112. One or more of the ESAs 106 may be implemented as one or more AESAs. In some embodiments, the processor 108 may be implemented as one or more radiofrequency (RF) processors.

While the communication system 104 is shown as having two ESAs 106, one processor 108, and memory 110, the communication system 104 may include any suitable number of ESAs 106, processors 108, and memory 110. Additionally, while the communication system 104 is shown as including the ESAs 106, the communication system 104 may include or be implemented with any suitable antenna(s) or antenna device(s). Further, the communication system 104 may include other components, such as a storage device (e.g., solid state drive or hard disk drive), radios (e.g., software defined radios (SDRs)), transmitters, receivers, transceivers, radio tuners, and controllers.

The computing device 112 of the aircraft 102 may include at least one processor 114, memory 116, and storage 118, as well as other components, equipment, and/or devices commonly included in a computing device, all of which may be communicatively coupled to one another. The computing device 112 may be configured to route data to the communication system 104 for transmission to an off-board destination (e.g., satellites 138, control station 132). Likewise, the computing device 112 may be configured to receive data from the communication system 104 transmitted from off-board sources (e.g., satellites 138, control station 132). The computing device 112 may include or be implemented as and/or be configured to perform the functionality of any suitable aircraft system, such as a flight management system (FMS). The processor 114 may be configured to run various software applications or computer code stored in a non-transitory computer-readable medium (e.g., memory 116 or storage 118) and configured to execute various instructions or operations. Additionally, for example, the computing device 112 or the processor 114 may be implemented as a special purpose computer or special purpose processor configured to execute instructions for performing any or all of the operations disclosed throughout. In some embodiments, the aircraft 102 may include any suitable number of computing devices 112.

The GPS device 120 receives location data from the GPS satellites 140 and may provide vehicular location data (e.g., aircraft location data) to any of various equipment/systems of the aircraft 102 (e.g., the communication system 104, the computing device 112, the aircraft sensors 122, the eye tracking system 124, the helmet-mounted display 126, the helmet tracking system 128, and the processing and video generation system 130). The GPS device 120 may include a GPS receiver and a processor. For example, the GPS device 120 may receive or calculate location data from a sufficient number (e.g., at least four) of GPS satellites 140 in view of the aircraft 102 such that a GPS solution may be calculated. In some embodiments, the GPS device 120 may be implemented as part of the computing device 112, the communication system 104, navigation sensors of the aircraft sensors 122, the eye tracking system 124, the helmet-mounted display 126, the helmet tracking system 128, and/or the processing and video generation system 130. The GPS device 120 may be configured to provide the location data to any of various equipment/systems of a vehicle. For example, the GPS device 120 may provide location data to the computing device 112, the communication system 104, the helmet tracking system 128, and/or the processing and video generation system 130. A processor (e.g., a processor of the GPS device, processor 114, processor 108, processor 404, processor 504, or a combination thereof) may determine the position and orientation of an operator (e.g., a pilot) wearing a helmet (e.g., 602, which may be implemented as or include the helmet-mounted display 126) based at least in part on the aircraft location data from the GPS device 120. Further, while FIG. 1 depicts the GPS device 120 implemented in the aircraft 102, in other embodiments, the GPS device 120 may be implemented in or on any type of vehicle, such as automobiles, spacecraft, trains, watercraft, or submersible craft.

The control station 132 includes at least one communication system 134 and at least one computing device 136, as well as other systems, equipment, and devices commonly included in a control station. Some or all of the communication system 134, the computing device 136, and other systems, equipment, and devices commonly included in a control system may be communicatively coupled. The control station 132 may be implemented as a fixed location ground control station (e.g., a ground control station of an air traffic control tower, or a ground control station of a network operations center) located on the ground 142 of the earth. In some embodiments, the control station 132 may be implemented as a mobile ground control station (e.g., a ground control station implemented on a non-airborne vehicle (e.g., an automobile or a ship) or a trailer). In some embodiments, the control station 132 may be implemented as an air control station implemented on an airborne vehicle (e.g., aircraft).

The communication system 134 and components thereof (such as ESA 106) of the control station 132 may be implemented similarly to the communication system 104 except that, in some embodiments, the communication system 134 may be configured for operation at a fixed location. The computing device 136 and components thereof (such as a processor (not shown) and memory (not shown)) of the control station 132 may be implemented similarly to the computing device 112.

While the ESAs 106 are exemplarily depicted as being implemented in the aircraft 102 and the control station 132, in some embodiments, ESAs 106 may be implemented in, on, or coupled to any other suitable device, equipment, or system, such as a computing device (e.g., a laptop computing device, a mobile computing, a wearable computing device, or a smart phone), a mobile communication system (e.g., a man pack communication system), or satellites 138.

Additionally, while the system 100 is shown as including the ESAs 106, the system 100 may include or be implemented with any suitable antenna(s) or antenna device(s).

While the communication system 104, the computing device 112, the GPS device 120, the aircraft sensors 122, the eye tracking system 124, the helmet-mounted display 126, the helmet tracking system 128, and the processing and video generation system 130 of the aircraft 102 have been exemplarily depicted as being implemented as separate devices or systems, in some embodiments, some or all of the communication system 104, the computing device 112, the GPS device 120, the aircraft sensors 122, the eye tracking system 124, the helmet-mounted display 126, the helmet tracking system 128, and/or the processing and video generation system 130 may be implemented as a single integrated system or device or as any number of integrated and/or partially integrated systems and/or devices.

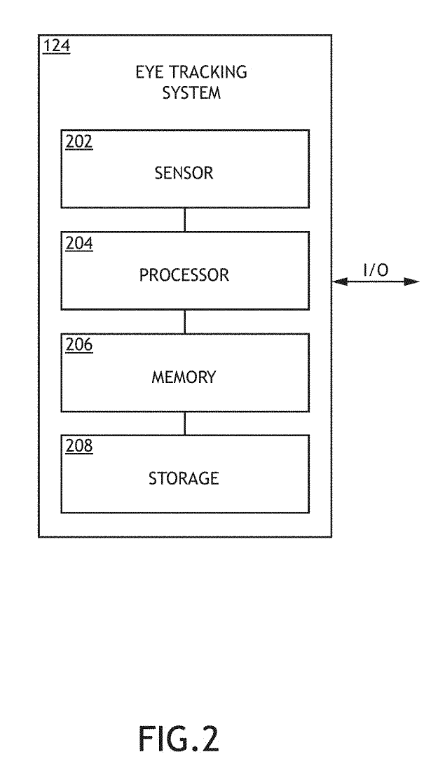

Referring now to FIG. 2, the eye tracking system 124 of FIG. 1 of an exemplary embodiment according to the inventive concepts disclosed herein is shown. The eye tracking system 124 is configured to track eye gestures, track movement of a user's eye, track a user's gaze, determine a location of a vergence point (sometimes referred to as a point of regard) of a user's gaze, determine eye locations, determine an intra-pupillary distance (IPD) between a user's eyes, determine a direction between a determined location of a user's eye and a determined location of a vergence point for each of a user's eyes, and/or otherwise receive inputs from a user's eyes. For example, the determined locations may be relative to a helmet (e.g., 602). The eye tracking system 124 may be configured for performing fully automatic eye tracking operations of users in real time. The eye tracking system 124 may include at least one sensor 202, at least one processor 204, memory 206, and storage 208, as well as other components, equipment, and/or devices commonly included in an eye tracking system. The sensor 202, the processor 204, the memory 206, and the storage 208, as well as the other components, equipment, and/or devices commonly included in an eye tracking system may be communicatively coupled.

Each sensor 202 may be implemented as any of various sensors suitable for an eye tracking system. For example, the at least one sensor 202 may include or be implemented as one or more optical sensors (e.g., at least one camera configured to capture images in the visible light spectrum and/or the infrared spectrum). In some embodiments, the at least one sensor 202 is one or more dedicated eye tracking system sensors. While the sensor 202 has been exemplarily depicted as being included in the eye tracking system 124, in some embodiments, the sensor 202 may be implemented external to the eye tracking system 124. For example, the sensor 202 may be implemented as an optical sensor (e.g., of the optical sensors 316 of the aircraft sensors 122) located within the aircraft 102 and communicatively coupled to the processor 204.

The processor 204 may be configured to process data received from the sensor 202 and output processed data to one or more onboard devices or onboard systems (e.g., the communication system 104, the computing device 112, the aircraft sensors 122, the eye tracking system 124, the helmet-mounted display 126, the helmet tracking system 128, and the processing and video generation system 130, or a combination thereof). For example, the processor 204 may be configured to determine a location of a vergence point of a user's gaze, determine eye locations, determine an intra-pupillary distance (IPD) between a user's eyes, and/or determine a direction between a determined location of a user's eye and a determined location of a vergence point for each of a user's eyes. Additionally, for example, the processor 204 may be configured to generate data associated with such determined information and output the generated data to the processing and video generation system 130. The processor 204 of the eye tracking system 124 may be configured to run various software applications or computer code stored in a non-transitory computer-readable medium and configured to execute various instructions or operations. The processor 204 may be implemented as a special purpose processor configured to execute instructions for performing any or all of the operations disclosed throughout.

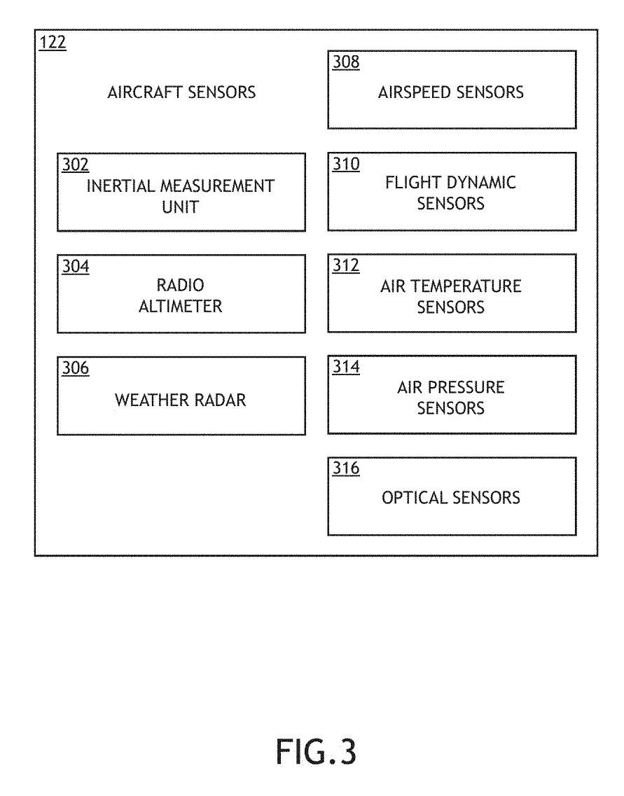

Referring now to FIG. 3, the aircraft sensors 122 of FIG. 1 are shown. Each of the aircraft sensors 122 may be configured to sense a particular condition(s) external to the aircraft 102 or within the aircraft 102 and output data associated with particular sensed condition(s) to one or more onboard devices or onboard systems (e.g., the communication system 104, the computing device 112, the aircraft sensors 122, the eye tracking system 124, the helmet-mounted display 126, the helmet tracking system 128, and the processing and video generation system 130, or a combination thereof). For example, the aircraft sensors 122 may include an inertial measurement unit 302, a radio altimeter 304, weather radar 306, airspeed sensors 308, flight dynamic sensors 310 (e.g., configured to sense pitch, roll, and/or yaw), air temperature sensors 312, air pressure sensors 314, and optical sensors 316. Additionally, the GPS device 120 may be considered as one of the aircraft sensors 122.

For example, at least some of the aircraft sensors 122 may be implemented as navigation sensors (e.g., the GPS device 120, the inertial measurement unit 302, a radio altimeter 304, weather radar 306, airspeed sensors 308, flight dynamic sensors 310, air temperature sensors 312, and/or air pressure sensors 314) configured to sense any of various flight conditions or aircraft conditions typically used by aircraft and output navigation data (e.g., aircraft location data, aircraft orientation data, aircraft direction data, aircraft speed data, and/or aircraft acceleration data). For example, various flight conditions or aircraft conditions may include altitude, aircraft location (e.g., relative to the earth), aircraft orientation (e.g., relative to the earth), aircraft speed, aircraft acceleration, aircraft trajectory, aircraft pitch, aircraft roll, aircraft yaw, air temperature, and/or air pressure. For example, the GPS device 120 and the inertial measurement unit 302 may provide aircraft location data and aircraft orientation data, respectively, to a processor (e.g., a processor of the GPS device 120, processor 114, processor 108, processor 404, processor 504, or combination thereof) such that the processor may determine the position and orientation of an operator (e.g., a pilot) wearing a helmet (e.g., 602, which may be implemented as or include the helmet-mounted display 126) based at least in part on the aircraft location data from the GPS device 120 and the aircraft orientation data from the inertial measurement unit 302.

Further, while the aircraft sensors 122 are implemented in or on the aircraft 102, some embodiments may include vehicle sensors implemented on any suitable vehicle according to the inventive concepts disclosed herein.

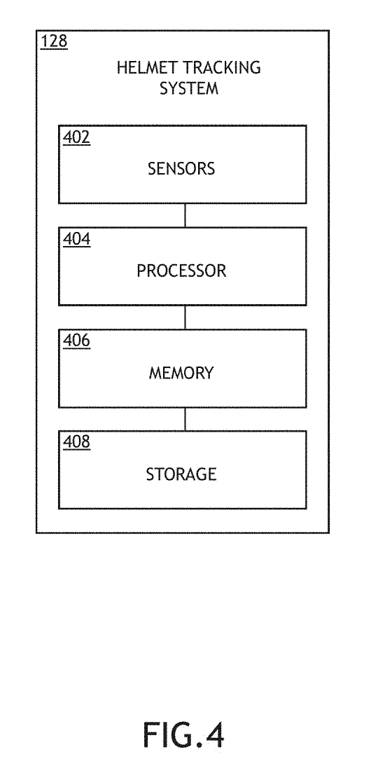

Referring now to FIG. 4, the helmet tracking system 128 of FIG. 1 is shown. The helmet tracking system 128 is configured to determine and track a location and an orientation of a user's helmet (e.g., 602) relative to the aircraft 102. The helmet tracking system 128 may be configured for performing fully automatic helmet tracking operations in real time. The helmet tracking system 128 may include sensors 402, at least one processor 404, memory 406, and storage 408, as well as other components, equipment, and/or devices commonly included in a helmet tracking system. The sensors 402, the processor 404, the memory 406, and the storage 408, as well as the other components, equipment, and/or devices commonly included in an eye tracking system may be communicatively coupled.

Each sensor 402 may be implemented as any of various sensors suitable for a helmet tracking system. For example, the sensors 402 may include or be implemented as one or more optical sensors (e.g., at least one camera (e.g., a camera configured to capture images in the visible light spectrum and/or the infrared spectrum)) configured to detect and/or image light reflected or emitted (e.g., by a light emitter (e.g., an infrared or visible light emitter (e.g., a light emitting diode (LED)) mounted on a helmet (e.g., 602)) off of or from a helmet (e.g., 602). Additionally, for example, the sensors 402 may include or be implemented as one or more optical sensors (e.g., at least one camera configured to capture images in the visible light spectrum and/or the infrared spectrum) configured to detect and/or image light reflected or emitted (e.g., by a light emitter (e.g., an infrared or visible light emitter (e.g., a light emitting diode (LED)) mounted on a portion of a cockpit of the aircraft 102) off of or from a portion of a cockpit of the aircraft 102. In some embodiments, the sensors 402 may be positioned at various locations in a cockpit of the aircraft 102 and/or various locations of a helmet (e.g., 602). The sensors 402 may configured to output data to the processor 404 such that the processor 404 may track and determine the location and orientation of a helmet (e.g., 602).

Further, for example, the sensors 402 may include or be implemented as one or more electromagnetic sensors (e.g., an array of radiofrequency identification (RFID) sensors) and/or acoustical sensors configured to output data to the processor 404 such that the processor 404 may track and determine the location and orientation of a helmet (e.g., 602).

In some embodiments, the sensors 402 are one or more dedicated helmet tracking system sensors. While the sensor 402 have been exemplarily depicted as being included in the helmet tracking system 128, in some embodiments, the sensors 402 may be implemented external to the helmet tracking system 128. For example, the sensors 402 may be implemented as optical sensors (e.g., of the optical sensors 316 of the aircraft sensors 122) located within the aircraft 102 and communicatively coupled to the processor 404.

The processor 404 may be configured to process data received from the sensors 402 and output processed data to one or more onboard devices or onboard systems (e.g., the communication system 104, the computing device 112, the aircraft sensors 122, the eye tracking system 124, the helmet-mounted display 126, the processing and video generation system 130, or a combination thereof). For example, the processor 404 may be configured to determine and track a location and orientation of a user's helmet (e.g., 602) relative to the aircraft 102. Additionally, for example, the processor 404 may be configured to generate data associated with such determined information and output the generated data to the processing and video generation system 130. The processor 404 of the helmet tracking system 128 may be configured to run various software applications or computer code stored in a non-transitory computer-readable medium and configured to execute various instructions or operations. The processor 404 may be implemented as a special purpose processor configured to execute instructions for performing any or all of the operations disclosed throughout.

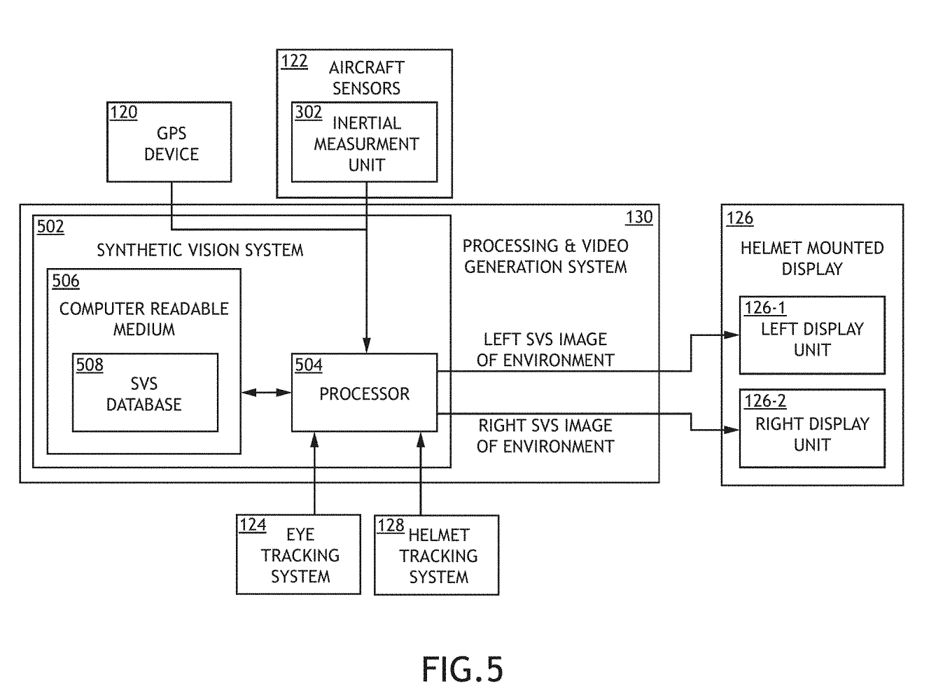

Referring now to FIG. 5, a portion of the aircraft 102 of FIG. 1 according to an exemplary embodiment according to the inventive concepts disclosed herein is shown. As shown in FIG. 5, the processing and video generation system 130 may include a synthetic vision system (SVS) 502, which may be communicatively coupled with the GPS device 120, the aircraft sensors 122 (e.g., the inertial measurement unit 302), the eye tracking system 124, the helmet tracking system 128, and the helmet-mounted display 126.

The SVS 502 includes at least one processor 504 and at least one computer readable medium 506 (e.g., a non-transitory processor readable medium, such as memory and/or storage), all of which may be communicatively coupled.

The computer readable medium 506 may be implemented within or as memory or a storage device, such as a hard-disk drive, solid state drive, or a hybrid solid state drive. In some embodiments, the computer readable medium 506 may store at least one data structure (e.g., at least one SVS database 508) of a flight environment. In some embodiments, the data structure contains data of a plurality of synthetic images or synthetic image components and aircraft states, wherein each of the plurality of synthetic images or synthetic image components may be associated with particular aircraft state data. The aircraft state data may include information of an aircraft's location and an aircraft's orientation, as well as other information. While the at least one data structure (e.g., the SVS database 508) is exemplarily depicted as being maintained in the computer readable medium 506, in some embodiments, one or more of the at least one data structure (e.g., the SVS database 508) may be maintained in any suitable computer readable medium (e.g., the memory 110, the memory 116, the storage 118, the memory 206, the storage 208, the memory 406, the storage 408, a memory of the computing device 136, a storage device of the computing device 136, or a combination thereof).

The processor 504 is configured to receive (e.g., receive in substantially real time) a stream of (a) aircraft location and orientation data (e.g., from the GPS device 120 and/or the inertial measurement unit 302) indicative of the aircraft 102's location and orientation relative to the earth, (b) helmet location and orientation data (e.g., from the helmet tracking system 128) indicative of a helmet's (e.g., 602's) location and orientation relative to the aircraft 102, and/or (c) eye location and orientation data (e.g., from the eye tracking system 124) indicative of locations and orientations of a pilot's eyes relative to the helmet (e.g., 602). Based on the aircraft location and orientation data, the helmet location and orientation data, and the eye location and orientation data, the processor 504 may be configured to determine, relative to the earth, the location and orientation of each of the pilot's eyes and a vergence point corresponding to the pilot's gaze.

Upon determining the location and orientation of each of the pilot's eyes and the vergence point relative to the earth, the processor 504 may be configured to access the data structure (e.g., the SVS database 508) of the computer readable medium 506 to obtain synthetic image data associated with the determined location and orientation of each of the pilot's eyes and the vergence point relative to the earth. The synthetic image data may be used by the processor 504 to construct synthetic views of the environment (e.g., the world outside of the aircraft) based on the determined location and orientation of each of the pilot's eyes and the vergence point relative to the earth. In a degraded visual environment, such as rain, fog, smoke, snow, or dust, the pilot might not be able to perceive the surrounding environment without the synthetic views.

Upon receiving synthetic image data associated with the determined location and orientation of each of the pilot's eyes and the vergence point relative to the earth, the processor 504 may be configured to generate (e.g., render) a pair of stereoscopic images, which includes a left image and a right image. Each image may be a synthetic representation of the environment as though viewed by the pilot from the pilot's current perspective; for example, each image may be a synthetic view of the world external to the aircraft as viewed from the pilot's current perspective. For example, the left image may correspond to an image generated from the perspective of a left virtual camera (e.g., 704-1) having a virtual location and virtual orientation corresponding to (e.g., matching) the pilot's left eye location and orientation such that the generated left image is focused on the vergence point from a viewpoint corresponding to the location of the pilot's left eye. Additionally, for example, the right image may correspond to an image generated from the perspective of a right virtual camera (e.g., 704-2) having a virtual location and virtual orientation corresponding to (e.g., matching) the pilot's right eye location and orientation such that the generated right image is focused on the vergence point from a viewpoint corresponding to the location of the pilot's right eye. In some embodiments, the left and right generated images substantially align with a pilot's normal three-dimensional (3D) perception with the distance between the left and right virtual cameras set as the pilot's Intra-Pupillary Distance (IPD). In some embodiments, such as where an exaggerated perception is desired, the left and right virtual cameras can be set with a distance between the left and right virtual cameras different from (e.g., greater than) the IPD.

As the processor 504 receives updated data (e.g., (a) aircraft location and orientation data, (b) helmet location and orientation data, and/or (c) eye location and orientation data), the processor 504 may be configured to iteratively determine an updated location and orientation of each of the pilot's eyes and an updated vergence point relative to the earth in substantially real time. Additionally, as the processor 504 determines the updated location and orientation of each of the pilot's eyes and the updated vergence point relative to the earth in substantially real time, the processor 504 may be configured to iteratively obtain synthetic image data associated with the most recently determined location and orientation of each of the pilot's eyes and the vergence point relative to the earth. Further, upon receiving synthetic image data associated with the most recently determined location and orientation of each of the pilot's eyes and the vergence point relative to the earth, the processor 504 may be configured to iteratively generate a pair of stereoscopic images such that each of the generated images are focused on a most recently updated vergence point as viewed from a most recently updated left or right eye viewpoint corresponding to a most recently determined location and orientation of the pilot's left or right eye, accordingly.

The processor 504 is configured to output a stream of generated left images to a left display unit 126-1 of the helmet-mounted display 126 and output a stream of generated right images to a right display unit 126-2 of the helmet-mounted display 126. The left display unit 126-1 is configured to present the stream of left images as video to the left eye of the pilot wearing a helmet (e.g., 602), which includes the helmet-mounted display 126. The right display unit 126-2 is configured to present the stream of right images as video to the right eye of the pilot wearing the helmet (e.g., 602), which includes the helmet-mounted display 126. Presentation of the left and right images to the pilot provides stereoscopic video to the pilot that adjusts (e.g., reactively adjusts) to the pilot's natural gaze, thereby allowing the pilot to focus on all objects in a depicted scene regardless of a distance from the aircraft 102.

In some embodiments, with respect to a single pair of stereoscopic images, the processor 504 may generate the left and right image substantially simultaneously; however, in some embodiments, the left and right image may be generated in an interlaced manner such that processor 504 generates the left image and then generates the right image, or vice versa.

The processor 504 may be configured to run various software applications or computer code stored in a non-transitory computer-readable medium (e.g., the computer-readable medium 506) and configured to execute various instructions or operations. The processor 504 may be implemented as a special purpose processor configured to execute instructions for performing any or all of the operations disclosed throughout.

While the processor 504 is exemplarily shown as being a single processor, some embodiments may include any suitable number of processors (e.g., two processors, such as a first processor configured to generate the left images and configured to perform operations associated thereto and a second processor configured to generate the right images and configured to perform operations associated thereto). Additionally, at least one processor 504 may be implemented as any suitable processor type(s) (e.g., at least one graphics processing unit (GPU), at least one image processor, at least one digital signal processor (DSP), at least one application specific integrated circuit (ASIC), at least one processor array, at least one field programmable gate array (FPGA), at least one microprocessor, at least one multi-core processor, or a combination thereof).

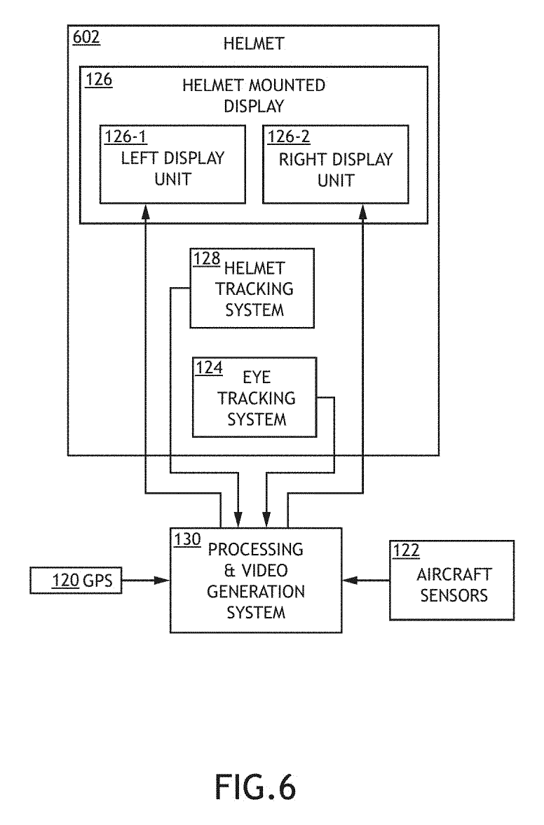

Referring now to FIG. 6, a portion of the aircraft 102 of FIG. 1 is shown. The processing and video generation system 130, the helmet-mounted display 126, the helmet tracking system 128, the eye tracking system 124, the GPS device 120, and the aircraft sensors 122 may be implemented and function similarly as shown and described with respect to FIG. 5. For example, a helmet 602 may include the helmet-mounted display 126, the helmet tracking system 128, and the eye tracking system 124. While the helmet-mounted display 126, the helmet tracking system 128, and the eye tracking system 124 are exemplarily depicted as being implemented in or on the helmet 602, in some embodiments, the helmet tracking system 128 and the eye tracking system 124 may be implemented as separate from the helmet 602. Further, while the helmet-mounted display 126 is exemplarily described and depicted throughout, some embodiments of the inventive concepts disclosed herein may be implemented as or include any suitable binocular display device, such as a binocular head-mounted display, a binocular retina projecting display device, or a combination thereof.

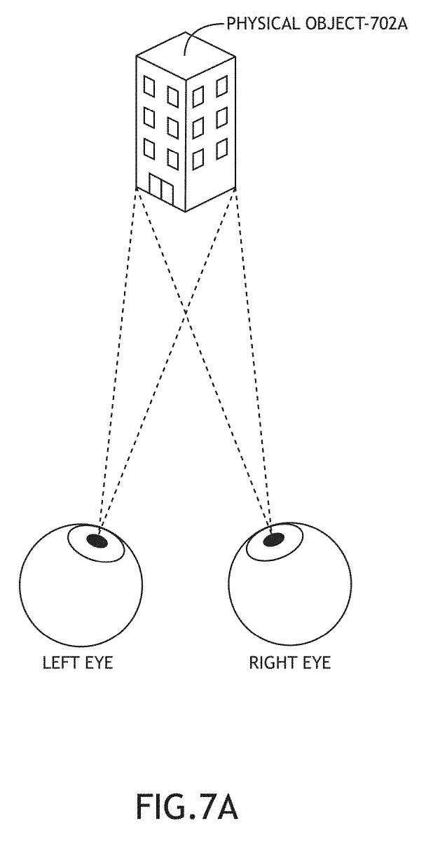

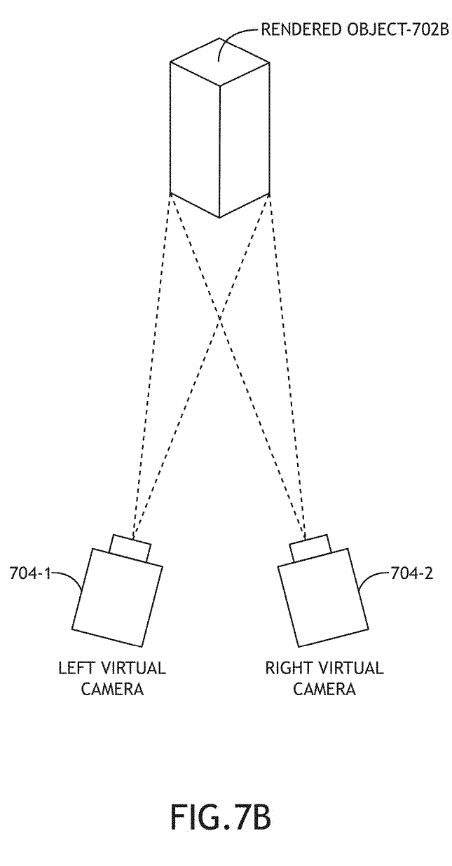

Referring now to FIG. 7A, an exemplary diagram of a pilot's eyes gazing on a physical object 702A according to an exemplary embodiment according to the inventive concepts disclosed herein is shown. FIG. 7A shows exemplary left eye and right eye locations (e.g., spaced apart by a particular distance (e.g., an Intra-Pupillary Distance (IPD)) and orientations corresponding to the pilot's gaze on the physical object 702A. The eye tracking system 124 may be configured to detect the location and orientation of the pilot's eyes and output corresponding eye location and orientation data, for example, to the processor 504.

Referring now to FIG. 7B, an exemplary diagram of a left virtual camera 704-1, a right virtual camera 704-2, and a rendered object 702B corresponding to the left eye and right eye gazing on the physical object 702A of FIG. 7A according to an exemplary embodiment of the inventive concepts disclosed herein is shown. Based at least on the eye location and orientation data, the processor 504 may be configured to determine the location and orientation of each of the pilot's eyes and a vergence point corresponding to the pilot's gaze. The processor 504 may be configured to access the data structure (e.g., the SVS database 508) of the computer readable medium 506 to obtain synthetic image data associated with the determined location and orientation of each of the pilot's eyes and the vergence point. The processor 504 may be configured to generate a pair of stereoscopic images, which includes a left image and a right image, of a rendered object 702B that corresponds to the physical object 702A. For example, the left image may correspond to an image generated from the perspective of a left virtual camera 704-1 having a virtual location and virtual orientation corresponding to (e.g., matching) the pilot's left eye location and orientation such that the generated left image is focused on the vergence point from a viewpoint corresponding to the location of the pilot's left eye. Additionally, for example, the right image may correspond to an image generated from the perspective of a right virtual camera 704-2 having a virtual location and virtual orientation corresponding to (e.g., matching) the pilot's right eye location and orientation such that the generated right image is focused on the vergence point from a viewpoint corresponding to the location of the pilot's right eye. As shown in FIG. 7B, the left and right generated images as rendered from the left virtual camera 704-1 and right virtual camera 704-2, respectively, substantially align with a pilot's normal 3D perception with the distance between the left virtual camera 704-1 and right virtual camera 704-2 set as the pilot's IPD as shown in FIG. 7A. In some embodiments, such as where an exaggerated perception is desired, the left and right virtual cameras can be set with a distance between the left and right virtual cameras different from (e.g., greater than) the IPD.

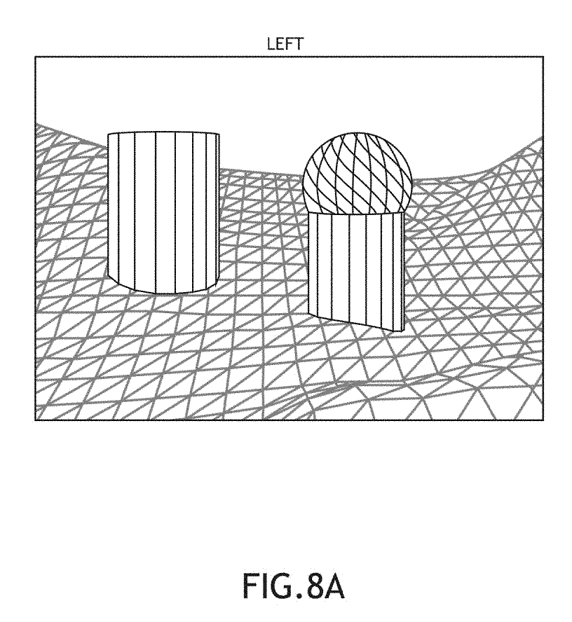

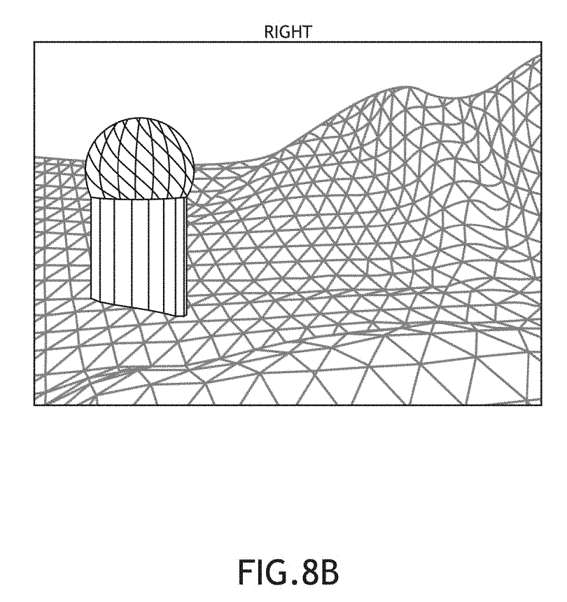

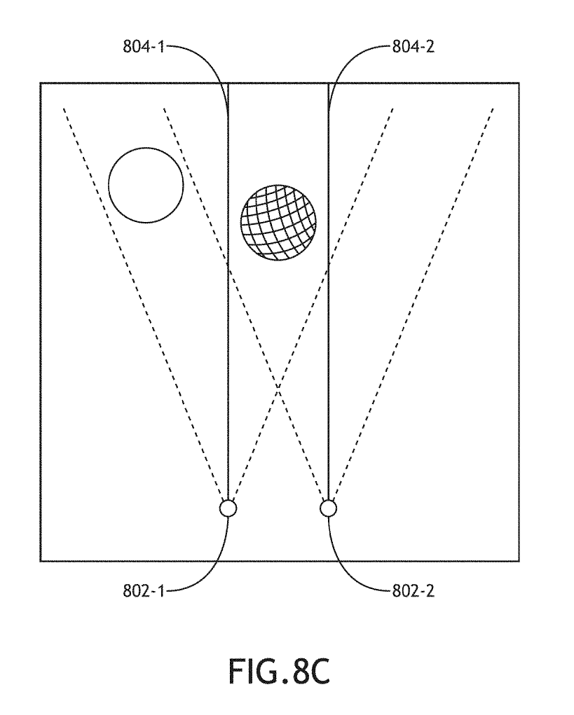

Referring now to FIGS. 8A-C, a left synthetic image (as shown in FIG. 8A) and a right synthetic image (as shown in FIG. 8B) of a synthetic vision scene rendered with substantially parallel vergence (parallel vergence is sometimes referred to as infinite vergence) according to an exemplary embodiment according to the inventive concepts disclosed herein are depicted. With true parallel vergence, there is no vergence point because a left vergence line 804-1 from the left virtual camera's location 802-1 would not intersect a right vergence line 804-2 from the right virtual camera's location 802-2. Substantially parallel vergence occurs when a user focuses his or her gaze at a distant object. As shown in FIG. 8A, the left synthetic image is rendered (e.g., by the processor 504) from the viewpoint of the left virtual camera's location 802-1 along the left vergence line 804-1. As shown in FIG. 8B, the right synthetic image is rendered (e.g., by the processor 504) from the viewpoint of the right virtual camera's location 802-2 along the right vergence line 804-2. As shown in FIG. 8C, a pilot presented with the left synthetic image (as shown in FIG. 8A) and the right synthetic image (as shown in FIG. 8B) would likely experience natural 3D perception with respect to distant objects.

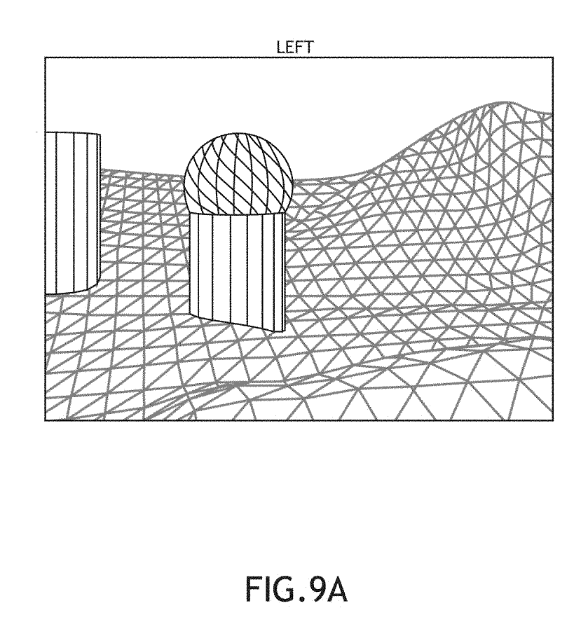

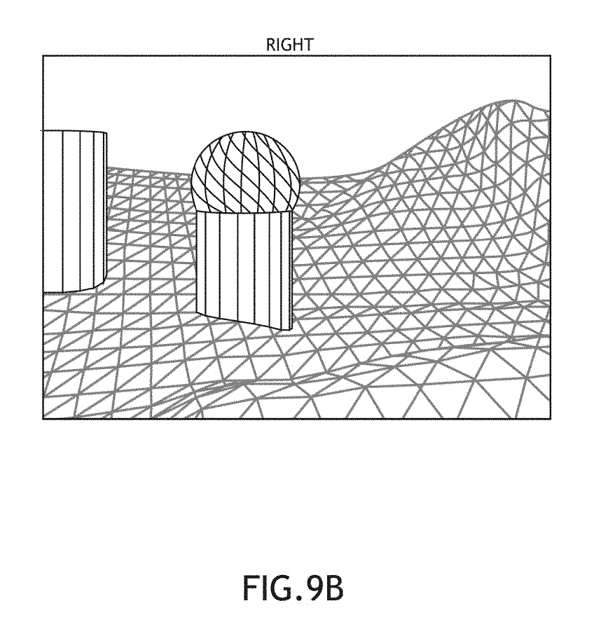

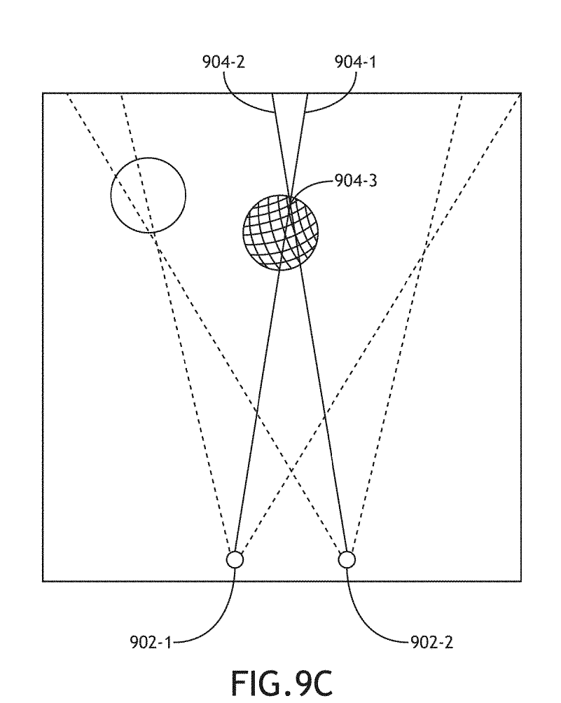

Referring now to FIGS. 9A-C, a left synthetic image (as shown in FIG. 9A) and a right synthetic image (as shown in FIG. 9B) of a synthetic vision scene rendered with vergence point 904-3 set on an object in a pilot's near field of vision according to an exemplary embodiment according to the inventive concepts disclosed herein are depicted. As shown in FIG. 9A, the left synthetic image is rendered (e.g., by the processor 504) from the viewpoint of the left virtual camera's location 902-1 along the left vergence line 904-1. As shown in FIG. 9B, the right synthetic image is rendered (e.g., by the processor 504) from the viewpoint of the right virtual camera's location 902-2 along the right vergence line 904-2. As shown in FIG. 9C, the vergence point 904-3 exists at the intersection of the left vergence line 904-1 (which extends from the viewpoint of the left virtual camera's location 902-1) and the right vergence line 904-2 (which extends from the viewpoint of the right virtual camera's location 902-2). When the pilot's gaze matches the vergence point 904-3, the pilot experiences natural 3D perception of the synthetic stereoscopic images, for example, that may be presented by the helmet-mounted display 126.

If the pilot changes his or her gaze in the synthetic vision scene, the eye tracking system 124 is configured to detect a change of the pilot's gaze. To accommodate the pilot's changed gaze and so that the pilot continues to experience natural 3D perception within the synthetic vision scene, the processor 504 is configured to generate and output updated synthetic images based at least on updated eye location and orientation data received from the eye tracking system 124.

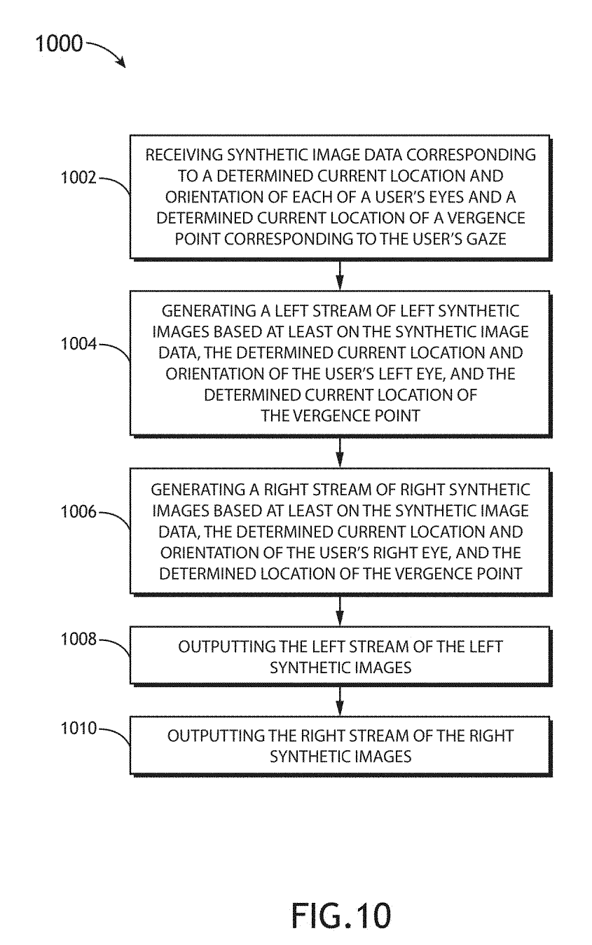

Referring now to FIG. 10, an exemplary embodiment of a method 1000 of according to the inventive concepts disclosed herein may include one or more of the following steps.

A step 1002 may include receiving synthetic image data corresponding to a determined current location and orientation of each of a user's eyes and a determined current location of a vergence point corresponding to the user's gaze. The step 1002 may be performed by at least one processor (e.g., the at least one processor 108, processor 114, the at least one processor 204, the at least one processor 404, the at least one processor 504, or a combination thereof).

A step 1004 may include generating a left stream of left synthetic images based at least on the synthetic image data, the determined current location and orientation of the user's left eye, and the determined current location of the vergence point. The step 1004 may be performed by the at least one processor (e.g., the at least one processor 108, processor 114, the at least one processor 204, the at least one processor 404, the at least one processor 504, or a combination thereof).

A step 1006 may include generating a right stream of right synthetic images based at least on the synthetic image data, the determined current location and orientation of the user's right eye, and the determined current location of the vergence point. The step 1006 may be performed by the at least one processor (e.g., the at least one processor 108, processor 114, the at least one processor 204, the at least one processor 404, the at least one processor 504, or a combination thereof).

A step 1008 may include outputting the left stream of the left synthetic images. The step 1008 may be performed by the at least one processor (e.g., the at least one processor 108, processor 114, the at least one processor 204, the at least one processor 404, the at least one processor 504, or a combination thereof).

A step 1010 may include outputting the right stream of the right synthetic images. The step 1010 may be performed by the at least one processor (e.g., the at least one processor 108, processor 114, the at least one processor 204, the at least one processor 404, the at least one processor 504, or a combination thereof).

Further, the method 1000 may include any of the operations disclosed throughout.

As will be appreciated from the above, embodiments of the inventive concepts disclosed herein may be directed to a method, a system, and a device. A processor (e.g., 504) may be configured to provide a left image stream and a right image stream to a binocular display device (e.g., the helmet-mounted display 126) configured to present a synthetic stereoscopic video stream to a user (e.g., a pilot), whereby the stereoscopic video stream may be adjusted in substantially real time to match the user's gaze as the gaze changes. When the user changes the direction of the user's gaze or a location of the user's eyes change, the processor (e.g., 504) generates left and right synthetic images as if viewed from current locations of the left eye and right eye, respectively, in a direction toward a currently determined vergence point (e.g., 904-3) which corresponds to (e.g., matches) the user's current gaze. The left display unit 126-1 and the right display unit 126-1 of the binocular display device display the left synthetic images and right synthetic images to the left and right eyes, respectively, of the user as stereoscopic video. By generating and displaying stereoscopic video as if viewed from the location of each eye of the user toward a current vergence point, the pilot can focus on all objects in the scene regardless of a distance from the user.

As used throughout, “at least one” means one or a plurality of; for example, “at least one” may comprise one, two, three, . . . , one hundred, or more. Similarly, as used throughout, “one or more” means one or a plurality of; for example, “one or more” may comprise one, two, three, . . . , one hundred, or more. Further, as used throughout, “zero or more” means zero, one, or a plurality of; for example, “zero or more” may comprise zero, one, two, three, . . . , one hundred, or more.

In the present disclosure, the methods, operations, and/or functionality disclosed may be implemented as sets of instructions or software readable by a device. Further, it is understood that the specific order or hierarchy of steps in the methods, operations, and/or functionality disclosed are examples of exemplary approaches. Based upon design preferences, it is understood that the specific order or hierarchy of steps in the methods, operations, and/or functionality can be rearranged while remaining within the scope of the inventive concepts disclosed herein. The accompanying claims may present elements of the various steps in a sample order, and are not necessarily meant to be limited to the specific order or hierarchy presented.

It is to be understood that embodiments of the methods according to the inventive concepts disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. A device, comprising:
a memory; and
at least one processor communicatively coupled to the memory, the at least one processor configured to:
receive synthetic image data corresponding to a determined current location and orientation of at least one of a left eye and a right eye of a user and a determined current location of a vergence point corresponding to a gaze of the user;
generate a left stream of left synthetic images based at least on the synthetic image data, a determined current location and orientation of the left eye of the user, and the determined current location of the vergence point;
generate a right stream of right synthetic images based at least on the synthetic image data, a determined current location and orientation of the right eye of the user, and the determined current location of the vergence point;
output the left stream of the left synthetic images; and
output the right stream of the right synthetic images.

2. The device of claim 1, wherein the left stream and the right stream are configured to be presented as stereoscopic video to the user.

3. The device of claim 1, wherein the at least one processor is further configured to receive a stream of the synthetic image data corresponding to the determined current location and orientation of each of the left eye and the right eye of the user and the determined current location of the vergence point corresponding to the gaze of the user, wherein a most recently generated left synthetic image of the left stream is generated based at least on most recent synthetic image data, most recently determined current location and orientation of the left eye of the user, and a most recently determined current location of the vergence point, and wherein a most recently generated right synthetic image of the right stream is generated based at least on the most recent synthetic image data, most recently determined current location and orientation of the right eye of the user, and the most recently determined current location of the vergence point.

4. The device of claim 1, wherein the at least one processor is further configured to:
receive at least one stream of data associated with a location and orientation of a vehicle relative to earth, a location and orientation of a helmet relative to the vehicle, and locations and orientations of at least one of the left eye and the right eye of the user relative to the helmet.

5. The device of claim 1, wherein the at least one processor is further configured to:
repeatedly determine, relative to earth, a current location and orientation of at least one of the left eye and the right eye of the user and a current location of the vergence point corresponding to the gaze of the user.

6. The device of claim 1, wherein the at least one processor is further configured to:
repeatedly determine, relative to earth, a current location and orientation of each of the left eye and the right eye of the user and a current location of the vergence point corresponding to the gaze of the user based at least on data associated with a location and orientation of a vehicle relative to earth, a location and orientation of a helmet relative to the vehicle, and locations and orientations of the eyes of the user relative to the helmet.

7. The device of claim 1, wherein the at least one processor is further configured to:
output the left stream of the left synthetic images to a left display unit configured to present the left stream as video to the left eye of the user; and
output the right stream of the right synthetic images to a right display unit configured to present the right stream as video to the right eye of the user.

8. A method, comprising:
receiving, by at least one processor, synthetic image data corresponding to a determined current location and orientation of at least one of a left eye and a right eye of a user and a determined current location of a vergence point corresponding to a gaze of the user;
generating, by the at least one processor, a left stream of left synthetic images based at least on the synthetic image data, a determined current location and orientation of the left eye of the user, and the determined current location of the vergence point;
generating, by the at least one processor, a right stream of right synthetic images based at least on the synthetic image data, a determined current location and orientation of the right eye of the user, and the determined current location of the vergence point;
outputting, by the at least one processor, the left stream of the left synthetic images; and
outputting, by the at least one processor, the right stream of the right synthetic images.

9. The method of claim 8, wherein the left stream and the right stream are configured to be presented as stereoscopic video to the user.

10. The method of claim 8, wherein receiving, by the at least one processor, the synthetic image data corresponding to the determined current location and orientation of the at least one of the left eye and the right eye of the user and the determined current location of the vergence point corresponding to the gaze of the user further comprises:
receiving, by the at least one processor, a stream of the synthetic image data corresponding to the determined current location and orientation of each of the left eye and the right eye of the user and the determined current location of the vergence point corresponding to the gaze of the user,
wherein a most recently generated left synthetic image of the left stream is generated based at least on most recent synthetic image data, most recently determined current location and orientation of the left eye of the user, and a most recently determined current location of the vergence point, and wherein a most recently generated right synthetic image of the right stream is generated based at least on the most recent synthetic image data, most recently determined current location and orientation of the right eye of the user, and the most recently determined current location of the vergence point.

11. The method of claim 8, further comprising:
receiving, by the at least one processor, at least one stream of data associated with a location and orientation of a vehicle relative to earth, a location and orientation of a helmet relative to the vehicle, and locations and orientations of at least one of the left eye and the right eye of the user relative to the helmet.

12. The method of claim 8, further comprising:
repeatedly determining, by the at least one processor, relative to earth, a current location and orientation of at least one of the left eye and the right eye of the user and a current location of the vergence point corresponding to the gaze of the user.

13. The method of claim 8, further comprising:
repeatedly determining, by the at least one processor, relative to earth, a current location and orientation of each of the left eye and the right eye of the user and a current location of the vergence point corresponding to the gaze of the user based at least on data associated with a location and orientation of a vehicle relative to earth, a location and orientation of a helmet relative to the vehicle, and locations and orientations of the eyes of the user relative to the helmet.

14. The method of claim 8, wherein outputting the left stream of the left synthetic images further comprises:
outputting, by the at least one processor, the left stream of the left synthetic images to a left display unit configured to present the left stream as video to the left eye of the user, and
wherein outputting the right stream of the right synthetic images further comprises:
outputting, by the at least one processor, the right stream of the right synthetic images to a right display unit configured to present the right stream as video to the right eye of the user.

15. A system for a vehicle, comprising:
a left display unit configured to present left images as video to a left eye of a user;
a right display unit configured to present right images as video to a right eye of the user; and
at least one processor communicatively coupled with the left display unit and the right display unit, the at least one processor configured to:
receive synthetic image data corresponding to a determined current location and orientation of at least one of the left eye and the right eye of the user and a determined current location of a vergence point corresponding to a gaze of the user;
generate a left stream of left synthetic images based at least on the synthetic image data, a determined current location and orientation of the left eye of the user, and the determined current location of the vergence point;
generate a right stream of right synthetic images based at least on the synthetic image data, a determined current location and orientation of the right eye of the user, and the determined current location of the vergence point;
output the left stream of the left synthetic images to the left display unit configured to present the left stream as video to the left eye of the user; and
output the right stream of the right synthetic images to the right display unit configured to present the right stream as video to the right eye of the user.

16. The system of claim 15, wherein the vehicle is an aircraft.

17. The system of claim 16, further comprising a binocular display device comprising the left display unit and the right display unit.

18. The system of claim 17, wherein the binocular display device is a binocular helmet-mounted display.

19. The system of claim 18, further comprising:
navigation sensors comprising at least one of a global positioning system (GPS) device or an inertial measurement unit, the navigation sensors communicatively coupled to the at least one processor, the navigation sensors configured to:
provide, to the at least one processor, data associated with a current location and orientation of the aircraft relative to earth.

20. The system of claim 19, further comprising:
a helmet for the user, wherein the helmet comprises:
the binocular helmet-mounted display comprising the left display unit and the right display unit;
a helmet tracking system comprising at least one helmet tracking system processor and at least one helmet tracking system sensor, the helmet tracking system communicatively coupled to the at least one processor, the helmet tracking system configured to:
provide, to the at least one processor, data associated with a current location and orientation of the helmet relative to the aircraft; and
an eye tracking system comprising at least one eye tracking system processor and at least one eye tracking system sensor, the eye tracking system communicatively coupled to the at least one processor, the eye tracking system configured to:
provide, to the at least one processor, data associated with a current location and orientation of each eye of the user relative to the helmet and associated with a current location of the vergence point relative to the helmet.
